(19) United States
(12) Patent Application Publication
(10) Pub. No.: US 2025/0222384 A1
(43) Pub. Date: Jul. 10, 2025

(54) FILTER ELEMENT AND FILTER DEVICE

(71) Applicant: MANN+HUMMEL GmbH, Ludwigsburg (DE)

(72) Inventors: Matthias STARZER, Landau an der Isar (DE); Joachim-Paul KRIEGER, Reisbach (DE); Johannes GRAD, Simbach (DE); Thomas VILSMAIER, Marklkofen (DE); Michael WANK, Coburg (DE); Volkmar CHOWANIETZ, Bayreuth (DE); Andreas WEBER, Freiberg (DE); Daniel SCHMID, Sachsenheim (DE)

(21) Appl. No.: 19/093,597

(22) Filed: Mar. 28, 2025

Related U.S. Application Data
(63) Continuation of application No. PCT/EP2023/074565, filed on Sep. 7, 2023.

(30) Foreign Application Priority Data
Oct. 4, 2022 (DE) 102022125471.2

(51) Int. Cl. B01D 46/12; B01D 46/52; B01D 46/62

(52) U.S. Cl. CPC B01D 46/12; B01D 46/521; B01D 46/62; B01D 2271/022

(57) ABSTRACT

A filter element has two filter bellows adjoining each other in an interface region between the outflow surface of one of the filter bellows and the inflow surface of the other. A circumferential seal in the interface region connects the filter bellows by material fusion. In transverse direction to the flow direction, one filter bellows has a small extension and the other a large extension larger than the small extension. The filter bellows are arranged such that, along an edge of the filter bellows with large extension, a free space in the interface region of the filter bellows with the large extension is not covered by the filter bellows with the small extension. In the free space region, the seal is connected by material fusion to the filter bellows with the large extension. A filter device with a two-part housing contains such a filter element.

### CROSS-REFERENCE TO RELATED APPLICATIONS

This application is a continuation application of international application No. PCT/EP2023/074565 having an international filing date of Sep. 7, 2023, and designating the United States, the international application claiming a priority date of Oct. 4, 2022, based on German patent application No. 10 2022 125 471.2, the entire contents of the aforesaid international application and the aforesaid German patent application being incorporated herein by reference.

### BACKGROUND

The present invention concerns a filter element, for example an air filter element, for an air filter system, for example for a cabin air filter system or an intake air filter system of a fuel cell. Furthermore, the invention concerns a filter device with such a filter element.

A filter element or filter insert is generally understood to be in the form of an insert that is exchangeably arranged as a unit in a filter housing and includes at least a filter medium body of a filter medium, frequently in the form of a folded filter bellows, and usually also a structure supporting or carrying the filter medium, and frequently also a seal. The filter medium usually has only a limited service life. Because of this, filter elements must be regularly exchanged as a unit.

The air flowing into a vehicle cabin is nowadays freed as completely as possible from contaminants. Possibly occurring contaminants are, for example, particulate matter, pollen, soot or aerosols. In situations in which high concentrations of plant protection agents or liquid fertilizer agents are present in the ambient air when using spray devices for these substances, filtering such contaminants is important. For this purpose, various filter means are available. For example, particle filters, active carbon filters, and HEPA filters are used. These filters are combined in various layers and various arrangements in order to obtain the desired filtration effect for the interior air.

Since in practice combinations of very different pollutants to be separated occur, the use of multi-stage filter systems or filter elements has been established.

EP 3 520 878 A1 discloses a filter module for filtering interior air with three filter layers, wherein the filter layers are arranged in a common frame which is assembled of extruded profile strips. One of the filter layers includes an adsorption filter formed as a honeycomb body while the other two filter layers include particle filters. The particle filter layers include separate filter bellows which may be flowed through in series, wherein one of the filter bellows includes a HEPA filter medium. The profile strips of the frame hold inwardly the multiple filter layers; outwardly, the filter module is fastened seal-tightly in a housing by means of the frame. The filter module includes moreover a circumferentially extending seal flange formed at the profile strips and protruding radially outwardly in the region of the two particle filter elements. The profile strips include furthermore two circumferentially extending collar sections which protrude inwardly at which two of the filter layers are supported, respectively. This construction in combination with the configuration of the particle filter layers as separate filter bellows requires a comparatively large installation space in axial direction.

A disadvantage in this respect is the comparatively complex configuration and the high material input associated therewith, as well as the manufacturing costs correlated therewith. Furthermore, due to the used material mix, there is a disposal problem because a purely thermal recycling is not possible.

Furthermore, WO 2015/092681 A1 discloses a filter element with two filter bellows which may be flowed through in series, and both include a cellulose-based filter medium. The two filter bellows adjoin each other in an abutting region and are held by a spacer at a predetermined distance in flow direction. The two filter bellows include the same dimensions transversely to the flow direction and are joined by a common circumferentially extending seal of a PUR material which in the abutting region is connected to the side faces of both filter bellows. A disadvantage in this respect is that the connection of both filter bellows is not sufficiently load-resistant which presents a problem for example in case of vibrations occurring in operation.

It is therefore desirable to provide a filter element that integrates a plurality of filter stages while being more mechanically load-resistant than known multi-stage filter elements.

### SUMMARY

In view of this background, the present invention has the object to provide an improved filter element.

This object is solved by a filter element, for example air filter element, for an air filter system, for example cabin air filter system or intake air filter system of a fuel cell, comprising two filter bellows which are arranged adjacent to each other in such a way in the direction of a predetermined flow direction that they may be flowed through in series, wherein the filter bellows each include an inflow surface and an outflow surface as well as at least four side faces, wherein the filter bellows adjoin each other in an interface region between the outflow surface of a first filter bellows and the inflow surface of a second filter bellows, and further comprising a circumferentially extending seal present in the interface region which connects the two filter bellows directly to each other by material fusion, wherein one of the filter bellows in the at least one direction transverse to the flow direction includes a smaller extension than the other filter bellows, wherein the filter bellows in the at least one direction transverse to the flow direction are arranged relative to each other in such a way that along at least one edge of the larger filter bellows in the interface region a free space is present at the inflow surface or outflow surface of the larger filter bellows which is not covered by the smaller filter bellows, wherein the circumferentially extending seal in the region of the free space is connected directly by material fusion to the inflow surface or outflow surface of the larger filter bellows.

The object is further solved by a filter device, for example of a cabin air filter system or an intake air filter system of a fuel cell, comprising a filter housing with two housing parts of which at least one includes a filter element receptacle in which a filter element is arranged, wherein the filter housing includes at least one circumferentially extending housing seal surface at which a circumferentially extending seal of the filter element rests seal-tightly, wherein the filter element of the filter device is a filter element in accordance with the invention.

Further embodiments of the invention are described in the following detailed description and the accompanying Figures of the drawings.

A filter element according to the invention is for example an air filter element for an air filter system, for example for a cabin air filter system or an intake air filter system of a fuel cell. The filter element includes two filter bellows which are arranged adjacent to each other in the direction of a predetermined flow direction such that they may be flowed through in series. The filter bellows each include an inflow surface and an outflow surface as well as at least four side faces. The filter bellows adjoin each other in an interface region between the outflow surface of a first filter bellows and the inflow surface of a second filter bellows. In the interface region, a circumferentially extending seal is present which connects the two filter bellows directly by material fusion to each other. One of the filter bellows includes in at least one direction transverse to the flow direction a smaller extension than the other filter bellows, wherein the filter bellows in the at least one direction transverse to the flow direction are arranged relative to each other such that along at least one edge of the larger filter bellows in the interface region a free space is present at the inflow surface or outflow surface of the larger filter bellows which is not covered by the smaller filter bellows. The circumferentially extending seal is connected in the region of the free space directly by material fusion to the inflow surface or outflow surface of the larger filter bellows.

Accordingly, the mechanical load resistance of the connection of both filter bellows is significantly improved in the filter element according to the invention. This is achieved inter alia by enlarged contact surfaces of the circumferentially extending seal which is integrally formed by material fusion at the filter bellows. Furthermore, the integral formation of the circumferentially extending seal at the inflow surface or the outflow surface of the larger filter bellows improves in addition the stiffness of the entire filter element which improves its handling for example during servicing.

The term “free space” refers to a virtual region which remains due to the smaller dimensions of one filter element in relation to the other filter element in the interface region at the inflow surface or the outflow surface of the larger filter element. In the finished filter element, the circumferentially extending seal is however mounted in this virtual free space, so that the region does not remain free, but is to be understood as an auxiliary means for describing the structural configuration of the filter element.

Advantageously, the filter element according to the invention may be comprised completely of thermally recyclable materials so that no disposal problems result and for example demounting of individual components of the filter element is not required in the recycling process.

In embodiments, the filter bellows and/or the filter element itself each are embodied in a cuboid shape. Cuboid components may be assembled inexpensively to the filter element and enable an efficient utilization of installation space.

Furthermore, in case of cuboid outer dimensions, symmetries relating to certain planes through the filter element may result which enable a beneficial mass distribution of the filter element.

An axial direction and radial direction of the filter element is used herein, wherein “axial” means in flow direction, i.e., perpendicular to an inflow surface or side of the filter element which, for example, is of a cuboid shape. The term “radial” means for example a normal direction of a side face or side wall of the frame or of a lateral surface of the cuboid filter element.

The respective filter bellows may include a filter medium which is, for example, a filter fabric, a laid filter material or a filter nonwoven. The filter medium may be produced by a spun-bond method or meltblown method. Furthermore, the filter medium may be felted or needled. The filter medium may include natural fibers, such as cotton, or synthetic fibers, for example, of polyester, polyphenyl sulfide or polytetrafluoroethylene.

In order to form the respective filter bellows, the filter medium is folded or corrugated multiple times. A fold distance of the filter bellows may lie, for example, between 3 and 5 mm and a fold height between 20 and 30 mm. In embodiments, 30 to 300 folds may be present.

In this context, the filter element according to the invention is suitable as an exchangeable component for an air filter system, for example for a cabin air filter system or an intake air filter system of a fuel cell and may be installed for example in a filter housing fixed in a vehicle.

In embodiments, the circumferentially extending seal may be additionally connected at the at least one edge of the larger filter bellows directly by material fusion to at least one side face of both filter bellows, respectively. This further improves the load resistance of the connection of both filter elements and increases the resulting stiffness of the filter element as a whole, for example in relation to an axial force load and/or bending about an axis transverse to the flow direction.

In embodiments, the circumferentially extending seal may include or may be comprised of a plastic material, for example a foamed polyurethane or a thermoplastic elastomer. The aforementioned materials may be provided excellently in a liquid or pasty initial state and, with the aid of a casting mold, may be integrally formed in a manner according to the invention directly by material fusion to both filter bellows. In the casting mold, the starting material provided in a liquid or pasty initial state cures and forms thereafter the final material of the circumferentially extending seal.

According to an embodiment, the circumferentially extending seal in cross section may include at least three legs, namely
a transverse leg which is connected to the inflow surface or outflow surface of the larger filter bellows, and
a first longitudinal leg which is connected to the side face of the smaller filter bellows, and
a second longitudinal leg which is connected to the side face of the larger filter bellows.

Advantageously, all three legs of the circumferentially extending seal may be produced in a common method step in a single tool (casting mold). In other words, the aforementioned legs-transverse leg, first longitudinal leg, and second longitudinal leg—may be referred to also as connecting legs of the circumferentially extending seal because they serve primarily as a connection of both filter bellows.

Moreover, the circumferentially extending seal may include a radially protruding circumferentially extending seal region which is formed so as to seal-tightly contact a housing seal surface of a filter housing. The seal region—adapted to the technical boundary conditions of the filter housing—may include various cross sections which appear suitable to a person of skill in the art. Thus, the seal region, for example, may be configured for a radially or axially acting sealing action and may include alternatively or additionally one or a plurality of seal lips or seal grooves. Advantageously, the seal region may be produced together with the connection legs of the circumferentially extending seal also in a common method step by casting.

In embodiments, the filter bellows each may have precisely four side faces, for example in case of a cuboid shape. However, also other basic shapes of the filter bellows are possible, for example certain polygons, for example with more than five corners.

According to an embodiment, the smaller filter bellows, in at least one further direction transverse to the flow direction, may include a smaller extension than the other filter bellows, wherein the filter bellows are arranged relative to each other in the at least one further direction transverse to the flow direction in such a way that along at least one further edge of the larger filter bellows in the interface region a free space at the inflow surface or outflow surface of the larger filter bellows is present which is not covered by the smaller filter bellows, wherein the circumferentially extending seal in the region of the free space is connected directly by material fusion to the inflow surface or the outflow surface of the larger filter bellows.

In embodiments, it is possible that, at the inflow surface or the outflow surface of the larger filter bellows, a free space remains at at least one pair of oppositely positioned edges, respectively. In other words, the smaller filter bellows may be arranged in this context so as to be displaced in two different directions, extending transversely to the flow direction, by a predetermined amount from the pair of oppositely positioned edges of the larger filter bellows, respectively. The connection of the circumferentially extending seal to the inflow surface or the outflow surface of the larger filter bellows in the region of the free space may be embodied in this context so as to extend completely around the circumference.

Furthermore, at least one of the filter bellows may include at least one particle filter medium, for example comprising a synthetic nonwoven material and/or a cellulose-based filter medium, wherein the particle filter medium fulfills for example filtration class H13 or H14 according to DIN EN 1822-1. As an alternative or in addition, at least one of the filter bellows may include at least one gas filter medium, for example comprising at least an adsorber, for example an active carbon, a zeolite and/or an ion exchanger. The gas filter medium may include also its own particle filter layer, for example comprising a synthetic nonwoven material. Alternatively, the gas filter medium may also include only a support layer which immobilizes the adsorber which is provided in granular or particle form, wherein the support layer may have a nonwoven material with a significantly larger pore size compared to the particle filter medium.

According to an embodiment, the smaller filter bellows may include the gas filter medium. On the one hand, this has the advantage that in the filter bellows with particle filter medium a larger filter surface is made available which is advantageous for example in case of a high-separation particle filter medium of the HEPA range. On the other hand, a further advantage resides in that, due to an edge of the smaller filter bellows facing the larger filter bellows being completely surrounded as a result of the circumferentially extending seal, an escape of adsorber, for example active carbon particles, to the exterior may be effectively prevented. Should adsorber particles become detached from the gas filter medium in operation, they do not reach the environment but are essentially caught in the interface region.

The filter bellows which includes the particle filter medium may be arranged upstream of the filter bellows which includes the gas filter medium. In this way, an air flow which passes through the filter element according to the invention may flow first through the filter bellows comprising the particle filter medium and subsequently through the filter bellows which includes the gas filter medium. This has the advantage that the gas filter medium may be flowed through by air which has been freed from particles, which improves the adsorption performance of the gas filter medium considered over time, because pores of the adsorber of the gas filter medium do not become “clogged” with particles.

Expressly independent of the aforesaid, it may be provided that the smaller filter bellows is arranged upstream and the larger filter bellows downstream.

Furthermore, the particle filter medium and/or gas filter medium may include an antimicrobial and/or anti-allergic action. As an antimicrobial substance, for example, zinc pyrithione or nanosilver, as an anti-allergic substance, for example, polyphenol is conceivable.

According to yet another embodiment, it may be provided that the smaller filter bellows includes an at least partially circumferentially extending frame element, for example comprising at least one lateral band attached to fold end face edges of the filter bellows and/or at least one head band attached to an end fold of the filter bellows. The lateral band and/or head band may include or be comprised of a synthetic nonwoven material. The lateral band for example seal-tightly glued to the fold profiles and the head band forms also a seal-tight closure relative to the folded filter medium.

According to yet another embodiment, the circumferentially extending seal may be connected directly by material fusion to the at least partially circumferentially extending frame element of the smaller filter bellows. This improves the mechanical load resistance of the connection of the two filter bellows even further and in addition has an advantageous effect on the stiffness of the filter bellows as a whole. Furthermore, in embodiments in which the smaller filter bellows includes the gas filter medium, a reduced escape tendency for adsorber particles present in the gas filter medium may be achieved by “framing” the smaller filter bellows by the frame element.

The direct material-fusion connection of the circumferentially extending seal may be, independent of the embodiment, a foamed connection, which is an industrially established process for example when using a polyurethane as starting material.

As an alternative or in addition, the larger filter bellows may include sealed fold end face edges, for example in the form of a fluid-tight adhesive connection of fold interstices and/or of at least one frame element attached to the fold end face edges. Due to the sealed end face edges, bypassing the filter medium of the larger filter bellows is prevented.

Furthermore, in the interface region a spacer element may be present which predetermines a distance of the two filter bellows relative to each other in the flow direction. The spacer element may extend for example with at least one component transversely to a fold length extension of at least one of the filter bellows in order to enable an optimal support at as many contact points as possible. A distance between the two filter bellows is in principle advantageous in order to achieve a uniform flow through both filter bellows. The spacer element serves however not only for supporting both filter elements in relation to each other but fulfills also a stabilization function for the filter element as a whole.

The spacer element may include an adhesive track applied to a plurality of fold tips of at least one of the filter bellows, at least one thread glued onto the fold tips and/or a lattice arranged in the interface region. The lattice may be comprised of a plastic material and for example be provided as an injection molded part: in this way, a particularly good reinforcement action of the spacer element may be achieved.

In embodiments, the lattice may include an at least partially circumferentially extending collar section which protrudes radially past the larger filter bellows. The collar section of the lattice may extend however completely circumferentially. The collar section of the lattice may be embedded for example in a material of the circumferentially extending seal, for example may be embedded by foaming in a material of the circumferentially extending seal. The collar section of the lattice may be for example surrounded completely by the material of the circumferentially extending seal.

The collar section of the lattice may extend for example at least partially in the plane in which the interface region is located. In embodiments, the collar section of the lattice may however also be angled at least in sections in relation to the plane of the interface region, for example in order to internally stiffen a seal region of the circumferentially extending seal. In embodiments, the collar section of the lattice may be angled in the direction toward the larger filter bellows.

The collar section is for example produced monolithically together with the material of the lattice and may be produced in a common process step together with the lattice.

In addition, at least one section of the lattice, viewed in radial direction, may extend past the collar section and beyond the circumferentially extending seal from an at least partially circumferentially extending protruding rim. The protruding rim may extend however completely circumferentially. The protruding rim is for example produced monolithically together with the material of the lattice and/or of the collar section and may be produced in a common process step together with the lattice and/or the collar section.

The collar section and/or the protruding rim may be comprised of a stiffer material than the circumferentially extending seal, for example of a plastic material, for example of an injection-moldable plastic material.

The protruding rim stiffens the filter element additionally, on the one hand; on the other hand, at least one fastening device may be formed thereat by means of which the filter element may be held in a filter housing. The fastening device may be a tab, for example, which includes at least one fastening element, for example, a through opening for screwing or a snap element.

The filter bellows may include different fold distances wherein a fold distance of the smaller filter bellows is larger than a fold distance of the larger filter bellows. Expressed alternatively, a fold distance in the filter bellows comprising the gas filter medium may be larger than a fold distance in the filter bellows comprising the particle filter medium.

A further aspect of the present invention concerns a filter device, for example of a cabin air filter system or an intake air filter system of a fuel cell. The filter device includes a filter housing with two housing parts of which at least one includes a filter element receptacle in which a filter element according to the invention is arranged. The filter housing includes at least one circumferentially extending housing seal surface at which a circumferentially extending seal of the filter element rests seal-tightly.

In embodiments, it may be provided that the circumferentially extending seal is axially compressed between the two housing parts when the filter element is arranged as intended in the filter housing.

Further possible implementations of the invention include also combinations, not explicitly mentioned, of features described previously or in the following in relation to embodiments. In this context, a person of skill in the art will also add individual aspects as improvements or supplements to the respective basic form of the invention. In the following, the invention will be explained in more detail with the aid of exemplary embodiments with reference to the accompanying drawing figures.

### BRIEF DESCRIPTION OF DRAWINGS

FIG. 1 shows an isometric view of a filter element according to the invention.

FIG. 2 shows a plan view of the filter element according to the invention.

FIG. 3 shows a section A-A according to FIG. 2.

FIG. 4 shows a side view of the filter element according to the invention with cutaway portion.

FIG. 5 shows detail Z according to FIG. 4.

FIG. 6 shows a longitudinal section view of a filter device according to the invention.

FIG. 7 shows a section view of a filter element according to a further embodiment of the invention.

FIG. 8 shows a section view of a filter element according to a further embodiment of the invention.

### DETAILED DESCRIPTION

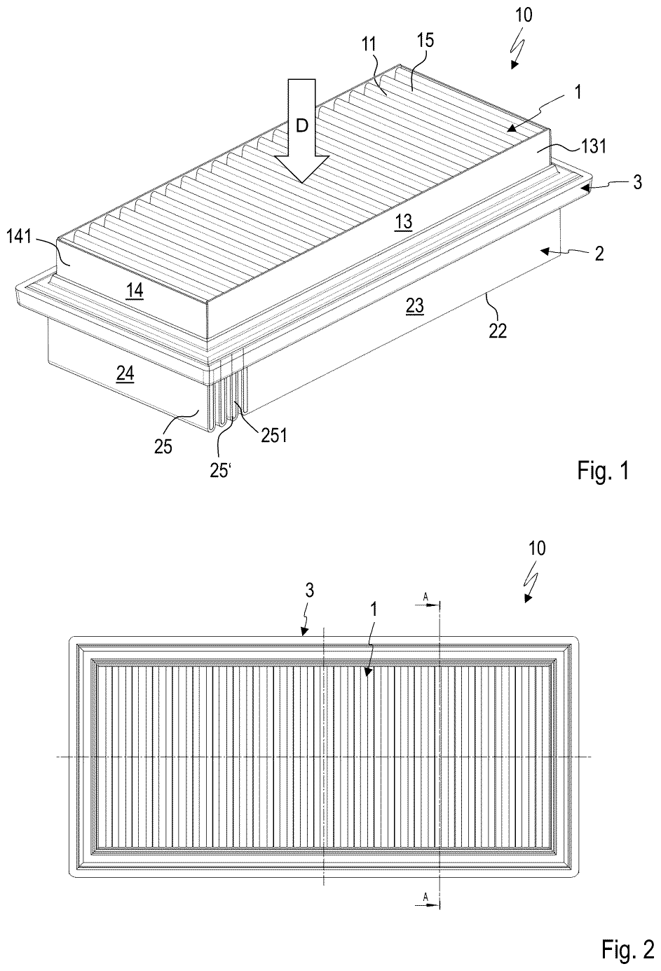

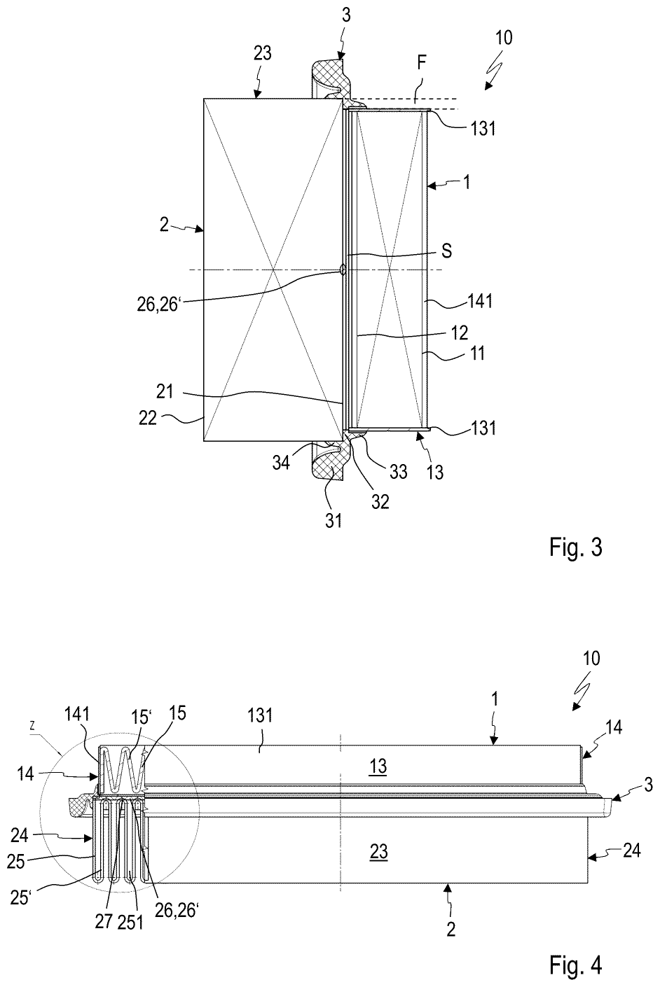

FIG. 1 shows the filter element 10 according to the invention in an isometric view. The filter element 10 comprises two filter bellows 1, 2 each with a filter medium laid into folds 15, 25, wherein the filter bellows 1, 2 are arranged adjacent to each other in direction of a predetermined flow direction D so that they may be flowed through in series. The filter bellows 1, 2 each have an inflow surface 11, 21 and outflow surface 12, 22 (see FIG. 3) as well as four side faces 13, 14, 23, 24. At the longitudinal ends of the folds 15, 25, the folded filter medium of the filter bellows 1, 2 comprises fold end face edges 15′, 25′, respectively (see FIG. 4). The first filter bellows 1 is arranged upstream of the second filter bellows 2. The first filter bellows 1 comprises for example a filter medium for gas filtration, for example with an active carbon as adsorber; the second filter bellows 2 comprises for example exclusively a particle filter medium.

The folded filter medium of the first filter bellows 1 is provided at its fold end face edges 15′ (see FIG. 4) with a lateral band 131, respectively, and at its end folds with a head band 141, respectively. The lateral bands 131 and head bands 141 represent a circumferentially extending frame element which frames the folded filter medium 15 of the first filter bellows 1.

The basic shape of the filter element 10 as a whole as well as of the filter bellows 1, 2 is cuboid, wherein a distinct long side as well as a distinct short side are present.

The filter element 10 comprises furthermore a circumferentially extending seal 3 connecting the two filter bellows 1, 2 and directly integrally formed thereat by material fusion, for example foamed on.

The second filter bellows 2 comprises sealed fold end face edges 25′ realized in the form of a fluid-tight adhesive connection of fold interstices 251 (see FIG. 4). As an alternative, a frame element which is applied to the fold end face edges 25′ of the filter medium of the second filter bellows 2 may be provided for sealing the fold end face edges.

The first filter bellows 1 is smaller than the second filter bellows 2, wherein “smaller” refers to the dimensions transverse to the flow direction D.

FIG. 2 shows the filter element 10 according to the invention in a plan view, wherein the first filter bellows 1 is positioned at the top.

FIG. 3 shows a section along the section plane A-A illustrated in FIG. 2 which extends parallel to the short sides 14, 24 of the filter element 10. In FIG. 3, the inner configuration of the filter element 10 may be seen, for example the connection of the two filter bellows 1, 2 by means of the circumferentially extending seal 3. The filter bellows 1, 2 adjoin each other in an interface region S between the outflow surface 12 of the first filter bellows 1 and the inflow surface 21 of the second filter bellows 2. The filter bellows 1, 2 are held by a spacer element 26 at a predetermined distance relative to each other in flow direction D. The spacer element 26 extends transversely to the fold length extension of at least one of the filter bellows 1, 2. The spacer element 26 is for example an adhesive track 26′ applied onto a plurality of fold tips 27 of the second filter bellows 2 or a thread which is glued onto the fold tips 27.

Since the first filter bellows 1 is smaller than the second filter bellows 2, at oppositely positioned edges of the larger filter bellows 2 a free space F remains at its inflow surface 21 in the interface region S which is not covered by the first filter bellows 1. The smaller first filter bellows 1 is arranged displaced in such a way that at the oppositely positioned edges of the larger second filter bellows 2 a free space F is present, wherein for example the respective free spaces F at the oppositely positioned edges of the larger second filter bellows 2 have the same dimensions.

In the region of the free space F, the circumferentially extending seal 3 is connected directly by material fusion to the inflow surface 21 of the larger second filter bellows 2. Furthermore, the circumferentially extending seal 3 is connected directly by material fusion to the side faces 13, 14 (see FIG. 4) of the smaller first filter bellows 1 as well as to the side faces 23, 24 (see FIG. 4) of the larger second filter bellows 2.

The two filter bellows 1, 2 are therefore connected to each other by the circumferentially extending seal 3.

Since the connection is realized via the respective side faces 13, 14, 23, 24 of the two filter bellows 1, 2 as well as via the inflow surface 21 of the second filter bellows 2, the contact surface of the circumferentially extending seal 3 relative to the filter bellows 1, 2 is maximized which contributes to a mechanically very load-resistant connection. The connection via the respective side faces 13, 14, 23, 24 of the two filter bellows 1, 2 as well as via the inflow surface 21 of the second filter bellows 2 may extend completely circumferentially.

In a radially protruding region of the circumferentially extending seal 3, a seal region 31 is present which contacts at least one seal surface arranged at the housing in a mounted state of the filter element 10.

In FIG. 4 which shows the filter element 10 in a side view in a projection direction along the short side faces 14, 24, the connection of the spacer element 26 to the fold tips 27 of the second filter bellows 2 may be seen.

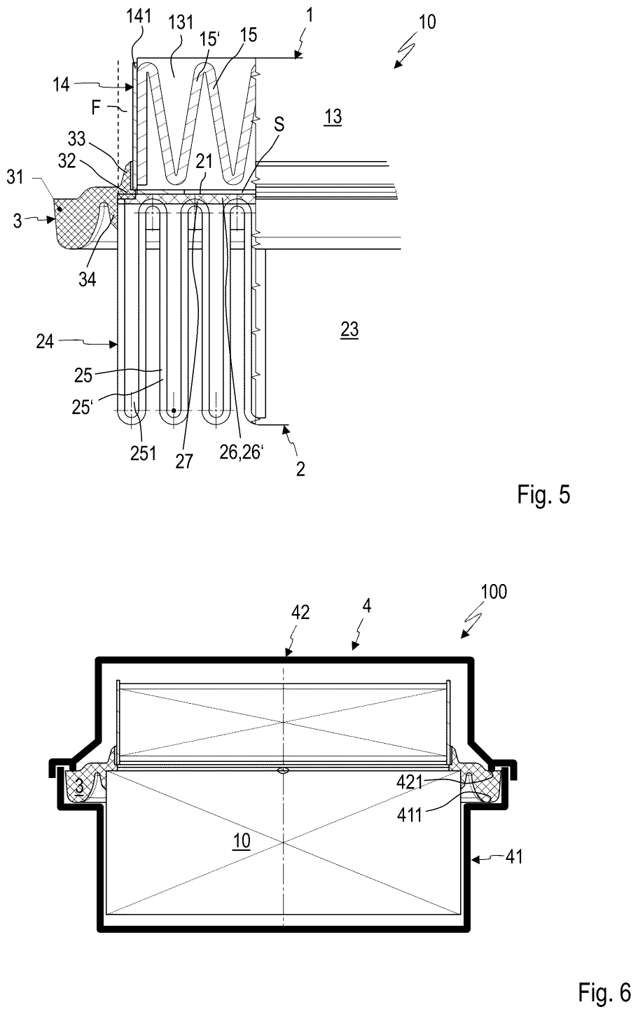

More will be explained with the aid of detail Z illustrated in FIG. 5.

The circumferentially extending seal 3 comprises thus a first longitudinal leg 33 which is connected to the side face 14 of the first filter bellows 1. More precisely, the first longitudinal leg 33 is connected to a head band 141 which is present at the side face 14 and which is present at an end fold of the folded filter medium of the first filter bellows 1. Furthermore, the circumferentially extending seal 3 comprises a second longitudinal leg 34 which is connected to the side face 24 of the second filter bellows 2. More precisely, the second longitudinal leg 34 is connected to an end fold of the filter medium of the second filter bellows 2. Finally, the circumferentially extending seal 3 comprises furthermore a transverse leg 32 which is connected to the inflow surface 21 of the second filter bellows 2. Furthermore, the transverse leg 32 is advantageously connected to an abutment surface of the head band 141 of the first filter bellows 1. In analogy, the transverse leg 32 may also be connected advantageously to an abutment surface of the lateral band 131 of the first filter bellows 1 which is illustrated in FIG. 3. The term “abutment surface” means an axially oriented cover surface. Due to the afore explained connection of the circumferentially extending seal 3 to the different contact surfaces of the two filter bellows 1, 2 and the T-shape resulting from the longitudinal legs 33, 34 and transverse leg 32 in the connection region of the two filter bellows 1, 2, the stiffness of the entire filter element 10 is advantageously significantly increased. The stiffness is further enhanced, for example in relation to bending about an axis transverse to the flow direction D, by the arrangement of the spacer element 26 in the interface region S.

FIG. 6 shows finally an installed state of the filter element 10 according to the invention in a filter housing 4 of an air filter system 100, for example of a cabin air filter system or an intake air filter system of a fuel cell. The filter housing 4 comprises two housing parts 41, 42 which together define a filter element receptacle. The bottom housing part 41 may be a housing pan and the upper housing part 42 a housing cover.

The first housing part 41 as well as the second housing part 42 each provide a circumferentially extending seal surface 411, 421 at which the seal region 31 of the circumferentially extending seal 3 of the filter element 10 rests seal-tightly. In this context, the seal region 31 of the circumferentially extending seal 3 is seal-tightly axially clamped between the housing parts 41, 42 by means of respective axial contact surfaces, facing the seal surface 411 of the first housing part 41 as well as the seal surface 421 of the second housing part 42. In order to improve the force transmission to the seal region 31 of the circumferentially extending seal 3, at least one of the housing parts 41, 42 comprises a circumferentially extending rib which pushes on the respective axially oriented contact surface of the seal region 31.

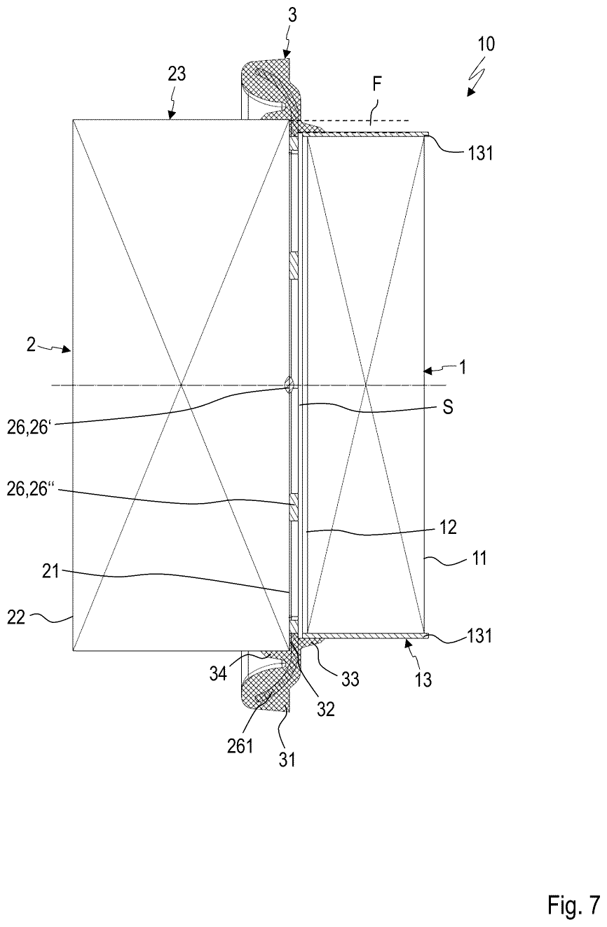

FIG. 7 illustrates a filter element 10 according to the invention according to a further embodiment in a longitudinal section view. The filter element 10 corresponds substantially to the filter element 10 illustrated in FIGS. 1 through 5 so that the features, feature combinations as well as their specific technical advantages described in relation to this filter element 10 as well as to the filter device 100 of FIG. 6 are applicable. In the following, only the differences will be explained.

The spacer element 26 comprises a lattice 26″ which is present in the interface region S between the two filter bellows 1, 2. The lattice 26″ is fluid-permeable and comprises for example a plurality of lattice openings between which lattice webs extend which contact the respective fold tips of the filter bellows 1, 2 facing the interface region S in order to space apart the filter bellows 1, 2 at a predetermined distance. The lattice 26″ has a circumferentially extending collar section 261 which protrudes radially past the larger second filter bellows 2. The collar section 261 of the lattice 26″ is embedded in the material of the circumferentially extending seal 3, for example is embedded by foaming in the material of the circumferentially extending seal 3. The collar section 261 of the lattice 26″ is for example surrounded completely, i.e., at all sides, by the material of the circumferentially extending seal 3.

The collar section 261 of the lattice 26″ extends with a first section in the plane in which the interface region S is positioned. In a second section, the collar section 261 is angled in relation to the plane of the interface region S in order to internally stiffen a seal region 31 of the circumferentially extending seal 3. The collar section 261 of the lattice 26″ is angled according to the embodiment in a direction oriented toward the larger second filter bellows 2. The angled second section may comprise a bend, a curve or a crease.

The collar section 261 is produced monolithically together with the material of the lattice 26″ and for example is produced by a common process step together with the lattice 26″.

When producing the filter element 10, first the lattice 26″ together with the collar section 261 formed thereat is provided and the two filter bellows 1, 2 are subsequently arranged thereat. In a subsequent step, the two filter bellows 1, 2 are connected by foaming or casting the circumferentially extending seal 3, whereby also the seal section 31 is formed, and the collar section 261 is embedded in the material of the circumferentially extending seal 3. Foaming or casting may be realized by means of a foaming or casting mold which comprises a negative contour of the circumferentially extending seal 3.

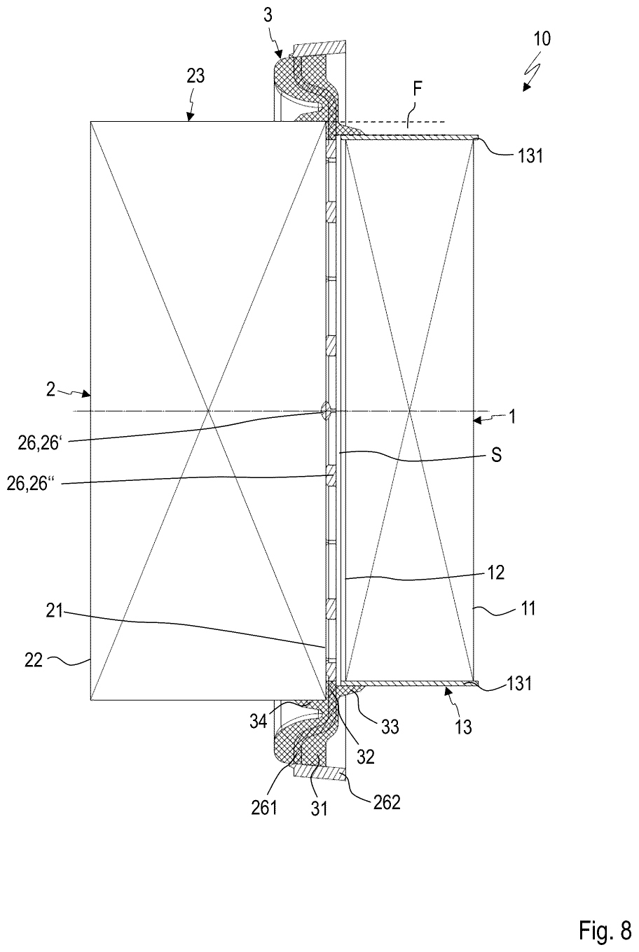

In addition, at least one section of the lattice 26″, viewed in radial direction, may extend past the collar section 261 and, beyond the circumferentially extending seal 3, may form an at least partially circumferentially extending protruding rim 262 which is illustrated in the longitudinal section view of the embodiment according to FIG. 8. The protruding rim 262 is not surrounded by the material of the circumferentially extending seal 3 and is for example exposed. The protruding rim 262 extends completely circumferentially along the circumferentially extending seal 3. The protruding rim 262 is produced monolithically together with the material of the lattice 26″ and of the collar section 261 and may be produced in a common process step together with the lattice 26″ and the collar section 261. The protruding rim 262 is for example embodied as a collar and angled in relation to a plane of the interface region S. The protruding rim 262 is angled for example in a direction which is oppositely oriented to the angled second section of the collar section 261.

The protruding rim 262 stiffens the filter element 10 on the one hand; on the other hand, at the protruding rim 262 a fastening device may be integrally formed by means of which the filter element 10 may be held in a filter housing. The fastening device may be, for example, a tab which comprises at least one fastening element, for example, a through opening for screwing or a snap element; this is however not illustrated in the drawing.

### REFERENCE CHARACTERS

100 filter device
10 filter element
1 first filter bellows
11 inflow surface of the first filter bellows
12 outflow surface of the first filter bellows
13, 14 side faces of the first filter bellows
131 lateral band of the first filter bellows
141 head band of the first filter bellows
15 folds of the first filter bellows
15′ fold end face edges of the first filter bellows
2 second filter bellows
21 inflow side of the second filter bellows
22 outflow side of the second filter bellows
23, 24 side faces of the second filter bellows
25 folds of the second filter bellows
25′ fold end face edges of the second filter bellows
251 fold interstices of the second filter bellows
26 spacer element
26 adhesive track
26 lattice
261 collar section of the lattice
262 protruding rim of the collar of the lattice
27 fold tips of the second filter bellows
3 circumferentially extending seal
31 seal region
32 transverse leg
33 first longitudinal leg
34 second longitudinal leg
D flow direction
F free space
S interface region
4 filter housing
41 first housing part
411 circumferentially extending seal surface of the first housing part
42 second housing part
421 circumferentially extending seal surface of the second housing part

What is claimed is:

1. A filter element comprising:
two filter bellows arranged adjacent to each other in a predetermined flow direction such that the two filter bellows are flowed through in series;
wherein the two filter bellows each comprise an inflow surface, an outflow surface, and four or more side faces;
wherein the two filter bellows adjoin each other in an interface region between the outflow surface of one of the two filter bellows and the inflow surface of the other one of the two filter bellows;
a circumferentially extending seal disposed in the interface region and connecting the two filter bellows directly to each other by a material fusion connection;
wherein, in a first transverse direction transverse to the predetermined flow direction, one of the two filter bellows comprises a first small extension and the other one of the two filter bellows comprises a first large extension, wherein the first large extension is larger than the first small extension;
wherein the two filter bellows in the first transverse direction are arranged relative to each other such that, along at least one first edge of the filter bellows comprising the first large extension, a first free space is present in the interface region at the inflow surface or the outflow surface of the filter bellows comprising the first large extension, wherein the first free space is not covered by the filter bellows comprising the first small extension;
wherein the circumferentially extending seal in a region of the first free space is connected directly by material fusion to the inflow surface or the outflow surface of the filter bellows comprising the first large extension.

2. The filter element according to claim 1, wherein the circumferentially extending seal at the at least one first edge of the filter bellows comprising the first large extension is additionally connected directly by material fusion to at least one of the side faces of the two filter bellows, respectively.

3. The filter element according to claim 1, wherein the circumferentially extending seal comprises a polyurethane or a thermoplastic elastomer plastic material.

4. The filter element according to claim 1, wherein the circumferentially extending seal comprises, viewed in cross section, at least a transverse leg connected to the inflow surface or the outflow surface of the filter bellows comprising the first large extension, a first longitudinal leg connected to one of the side faces of the filter bellows comprising the first small extension; and a second longitudinal leg connected to one of the side faces of the filter bellows comprising the first large extension.

5. The filter element according to claim 1, wherein the circumferentially extending seal comprises a radially protruding circumferentially extending seal region configured to seal-tightly contact a housing seal surface of a filter housing.

6. The filter element according to claim 1, wherein the two filter bellows each comprise precisely four side faces and/or each comprise a cuboid basic shape.

7. The filter element according to claim 1, wherein, in at least one second transverse direction transverse to the predetermined flow direction, the filter bellows comprising the first small extension further comprises a second small extension and the filter bellows comprising the first large extension further comprises a second large extension, wherein the second large extension is larger than the second small extension, wherein the two filter bellows, in the at least one second transverse direction, are arranged relative to each other such that, along at least one second edge of the filter bellows comprising the second large extension, a second free space is present in the interface region at the inflow surface or the outflow surface of the filter bellows comprising the second large extension, wherein the second free space is not covered by the filter bellows comprising the second small extension, wherein the circumferentially extending seal in a region of the second free space is connected directly by material fusion to the inflow surface or the outflow surface of the filter bellows comprising the second large extension.

8. The filter element according to claim 1, wherein at least one of the two filter bellows comprises at least one particle filter medium and/or at least one of the two filter bellows comprises at least one gas filter medium.

9. The filter element according to claim 8, wherein the at least one particle filter medium comprises a synthetic nonwoven material and/or a cellulose-based filter medium.

10. The filter element according to claim 8, wherein the at least one gas filter medium comprises at least one adsorber.

11. The filter element according to claim 10, wherein the at least one adsorber is selected from the group consisting of an active carbon, a zeolite, and an ion exchanger.

12. The filter element according to claim 8, wherein the filter bellows comprising the first small extension comprises the at least one gas filter medium.

13. The filter element according to claim 1, wherein the filter bellows comprising the first small extension comprises an at least partially circumferentially extending frame element.

14. The filter element according to claim 13, wherein the at least partially circumferentially extending frame element comprises at least one lateral band applied to fold end face edges of the filter bellows comprising the first small extension and/or at least one head band applied to an end fold of the filter bellows comprising the first small extension.

15. The filter element according to claim 14, wherein the circumferentially extending seal is connected directly by material fusion to the at least partially circumferentially extending frame element.

16. The filter element according to claim 1, wherein the filter bellows comprising the first large extension comprises fold end face edges which are sealed to form sealed fold end face edges, and wherein the sealed fold end face edges comprise a fluid-tight adhesive connection of fold interstices and/or at least one frame element applied to the fold end face edges.

17. The filter element according to claim 1, further comprising at least one spacer element arranged in the interface region in the predetermined flow direction predetermines a distance of the two filter bellows relative to each other, wherein the spacer element comprises at least one component extending transversely to a fold length extension of at least one of the two filter bellows, and wherein the spacer element is selected from the group consisting of an adhesive track applied to fold tips of at least one of the two filter bellows; at least one thread glued to fold tips of at least one of the two filter bellows; and a lattice arranged in the interface region.

18. The filter element according to claim 1, wherein the filter bellows comprising the first small extension has a first fold distance and the filter bellows comprising the first large extension has a second fold distance, wherein the first fold distance is larger than the second fold distance.

19. A filter device comprising:
a filter housing comprising two housing parts, wherein at least one of the two housing parts comprises a filter element receptacle;
a filter element according to claim 1 arranged in the filter element receptacle;
wherein the filter housing comprises at least one circumferentially extending housing seal surface at which the circumferentially extending seal of the filter element rests seal-tightly.

20. The filter device according to claim 19, wherein the circumferentially extending seal of the filter element is axially compressed between the two housing parts when the filter element is arranged as intended in the filter housing.
